(19) United States
(12) Patent Application Publication
(10) Pub. No.: US 2010/0141186 A1
(43) Pub. Date: Jun. 10, 2010

(54) ELECTRIC TOOL AND DEVICE SWITCH FOR AN ELECTRIC TOOL

(76) Inventors: Steffen Katzenberger, Bad Liebenzell (DE); Stefan Rapp, Goeppingen-Jebenhausen (DE); Gunter Flinspach, Leonberg (DE); Markus Schmid, Wolfschlugen (DE)

Correspondence Address: RONALD E. GREIGG;GREIGG & GREIGG P.L.L.C., 1423 POWHATAN STREET, UNIT ONE, ALEXANDRIA, VA, 22314, US

(21) Appl. No.: 12/597,440

(22) PCT Filed: Apr. 9, 2008
(86) PCT No.: PCT/EP08/54279

§ 371 Date: Feb. 17, 2010

(30) Foreign Application Priority Data
Apr. 24, 2007 (DE) 10 2007 019 683.2
Mar. 17, 2008 (DE) 10 2008 000 704.8

(51) Int. Cl. H02P 29/02; H02P 7/285

(52) U.S. Cl. 318/139; 318/473; 318/434

(57) ABSTRACT

The invention relates to a device switch for an electric tool, in particular a battery-operated electric tool. A power circuit for supplying power of a motor and an electronic circuit for monitoring the temperature, power and current is integrated into the device switch. The invention moreover relates to a method for monitoring an electric tool, in particular an electric tool with rechargeable battery operation.

The invention relates to a device switch for an electric tool, in particular an electric tool with rechargeable battery operation, as generically defined by the preamble to claim 1, and to an electric tool, in particular an electric tool with rechargeable battery operation, as generically by the preamble to claim 10. The invention moreover relates to a method for monitoring an electric tool, in particular an electric tool with rechargeable battery operation, as generically defined by the preamble to claim 15.

Electric tools, in particular electric tools that can be operated with a rechargeable battery, are known in manifold version, for instance as power drills or cordless screwdrivers. As described for instance in German Patent Disclosure DE 40 38 786 A1, such electric tools have a device switch for the user control and regulation of the tool rpm. This is attained by integrating an electronic unit in the device switch; this unit has a power circuit for controlling and regulating the rpm. In the control case, the motor driving the tool is supplied with current from a voltage source, in particular a rechargeable battery, in such a way that the current delivered flows out via a power semiconductor, whose conductivity is determined in the final analysis by way of the pressing position of the manual switch button. This makes power control of the electric motor possible. For power control, a power transistor and optionally a heat sink required for it can be provided.

It is also known to monitor the temperature in the power component. To that end, it is proposed for instance in German Patent Disclosure DE 10 2005 010 129 A1 that when a predetermined limit temperature is reached, the power of the load is reduced, for instance by reducing the flowing load current. For reaching the maximum rpm, a second contact, the so-called bridging contact, is closed once approximately 80% of the maximum rpm is reached, so that the full voltage of the rechargeable battery is then applied to the motor.

Temperature control is also known from Japanese Patent Disclosure JP 2006 166601. In it, overheating protection in an electric tool is achieved by detecting the temperature using a temperature sensor embodied as a temperature-dependent resistor. Thus the current delivered to the motor can be reduced via a control element in such a way that the temperature drops again. The overheating protection proposed here is mounted on the motor outside the pressure switch with which the tool rpm can be varied.

According to the invention, a device switch for an electric tool is now proposed, with an integrated protection circuit with which the rpm of the electric tool can be varied as a function of a monitored temperature, the voltage applied to the voltage supply, in particular to the rechargeable battery, and the current. This circuit is preferably embodied in analog form.

Preferably, the protection circuit is embodied and implemented such that it acts directly on a power circuit provided in the device switch, and thus a change can be made from a critical to a noncritical operating state.

Primarily for reasons of reducing costs, the protection circuit can be provided as an analog protection circuit in the power circuit.

An electric tool having this kind of device switch is also proposed, so that the electric tool itself can be protected against damage.

With the method according to the invention, an electric tool, in particular an electric tool with rechargeable battery operation, can be monitored with a device switch; the device switch has a power circuit for speed control and/or regulation of a motor. Both the temperature of at least one temperature-sensitive component of the electric tool, and the current that flows through the power circuit, as well as the actual voltage of the voltage supply, in particular the rechargeable battery, can all be monitored. As a function of the monitored values for the temperature, the current and the voltage, it is thus possible with the protection circuit, which is disposed in the housing switch, to effect a speed control and/or regulation and/or a partial or complete shutoff of individual components of the electric tool.

For the monitoring, in a preferred embodiment of the invention, the protection circuit acts directly on the power circuit.

The protection circuit may be embodied such that with it, the rpm in a predetermined range is controlled and/or regulated, and if this range is exceeded, the value for the rpm can be set to the maximum possible value. The predetermined regulation range may encompass the entire rpm range of the electric tool. It is also possible to restrict the regulation to a defined regulation range, such as between 0% and 50% of the maximum possible rpm range.

If the attainment or overshooting of a defined temperature of a monitored component is detected, then a change is made to a safe mode of operation. It is equally possible upon attaining or undershooting of a predetermined minimum input voltage for the electric tool to be shut off. Thus rechargeable batteries in particular, which are constructed on the basis of lithium ions, can be treated gently and protected against total discharge.

With the device switch of the invention, the electric tool of the invention, and the method proposed according to the invention, it is now possible to ensure monitoring of temperature-sensitive components, such as the motor, the electric or electronic components employed, and the cells and cell clusters, and if defined temperature threshold values are exceeded, to take provisions for protecting these components. Simultaneously, by the monitoring of the current, the current-carrying components, that is, cell, cell cluster, power component, switch with switch contacts, lines, and motor, can be protected against an excessively high current consumption or current output. Thus thermal protection of the power component can be attained as well. With the simultaneous monitoring of the voltage, a change and in particular a drop in the rechargeable battery voltage below a defined set-point value can furthermore be detected. Thus the rechargeable battery can be treated gently, since it thus becomes possible to shut off the rechargeable battery as a function of the monitored voltage, for instance upon reaching the discharge termination voltage.

Further advantages and advantageous embodiments of the invention are the subject of the ensuing drawings as well as their descriptions. In detail, they show the following:

FIG. 1: schematically, a device switch of an electric tool;

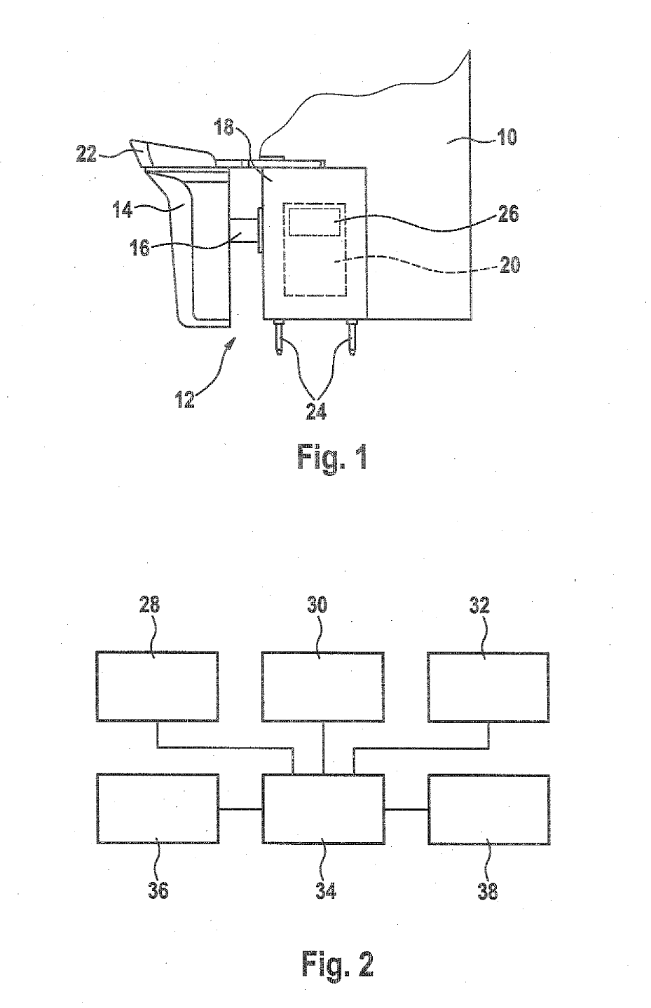

FIG. 2: a block circuit diagram of a first embodiment of a functionality integrated with the device switch;

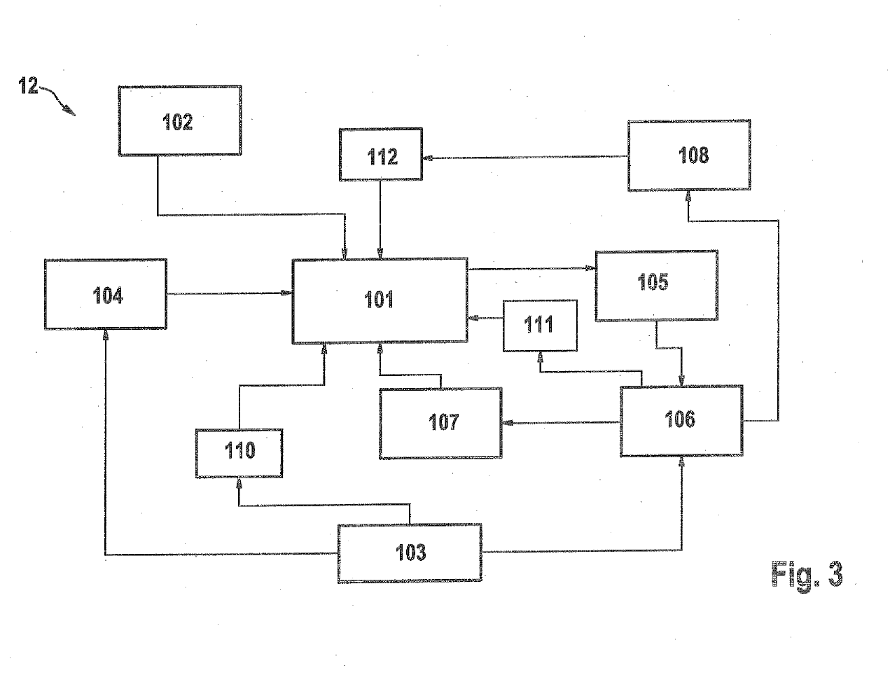

FIG. 3: a block circuit diagram of a second embodiment of a functionality integrated with the device switch.

FIG. 1 shows a device switch 12 for a schematically indicated electric tool 10, such as a cordless screwdriver, power drill, or the like. The device switch 12 has a trigger 14, which is seated on a trigger axle 16 and is connected to a device switch housing 18. Via the trigger 14, a user can manually actuate the electric tool 10 and can for instance vary an rpm. A reversing lever 22 can also be provided, for reversing a direction of rotation. The device switch 12 can be connected to a voltage source, in particular a rechargeable battery, by terminals 24. Electric or electronic components, which also include a power circuit 20 indicated by dashed lines, are accommodated in the interior of the device switch housing 18. This power circuit 20 serves to control and regulate the current flowing to the load. Typically, it has a power transistor, such as a power MOSFET.

A protection circuit 26 is provided in the device switch 12 and is preferably integrated together with the power circuit 20 on a common circuit board. Sensors are also provided for monitoring temperatures, current intensities, and voltages. With the protection circuit 26, the monitored values of temperature, applied voltage, and current can be evaluated in such a way that monitoring and protection of vulnerable components, such as the motor, the electric or electronic components employed, the cells of the rechargeable battery, and the cell clusters can be ensured. Temperature-sensitive components such as the motor, the electric or electronic components, and the rechargeable battery cells and rechargeable battery packs, are protected against overheating. Rechargeable battery cells and rechargeable battery packs are protected against excessive discharge (total discharge). Current-carrying components, such as rechargeable battery cells, rechargeable battery packs, rechargeable battery contacts, lines, power electronics, and the motor, are protected against excessive current intensities. As a result, the reliability and service life of these components are increased. Moreover, by the avoidance of component defects, both property damage and personal injury can be avoided. By the limitation of the maximum current intensity in the power circuit 20, a limitation is also attained of the maximum torque furnished by the electric tool 10. As a result, once again personal injury and property damage are avoided.

In FIG. 2, a block circuit diagram is schematically shown for a first embodiment of the functionality, which according to the invention is integrated with the device switch 12, of the power and protection circuits 20, 26. A voltage supply 28, in particular a rechargeable battery, is provided, so that the electric tool can be supplied with a sufficient voltage. A temperature detection and signal preparation unit 30 and a voltage detection and signal preparation unit 32 are provided. The units 28, 30 and 32 are connected to a logic unit 34. The logic unit 34 makes it possible to process the actual input values arriving from the units 28, 30 and 32, and in particular to compare them with set-point values, stored in memory, of a set-point value memory 36. Depending on the results ascertained from the comparison of the set-point values with the actual values, a power final control element 38 can be triggered for controlling the power current. Current and temperature monitoring can also be integrated with the power final control element 38 but can also be provided separately.

With the device switch 12 shown, it is possible for the rpm of the electric tool 10 to be controlled and/or regulated over the entire control and/or regulating range from 0% to 100%. Alternatively, the rpm regulation can be done only within an arbitrarily adjustable range, such as between 0% and 40%. In that case, the range from 41% to 100% remains blocked out, and if the maximum regulating range value of 40% is exceeded, a jump is made to 100%, that is, to the maximum possible value for the rpm.

The protection circuit 26 is preferably embodied in analog form. This makes for an economical embodiment. With this protection circuit 26, which is also preferably embodied such that it can act directly on the power circuit 20, it is possible to ensure limit value monitoring simultaneously for various relevant parameters in operation of the electric tool 10. The maximum temperature for various elements of the electric tool 10, such as the temperature of a rechargeable battery provided, or of the power component, can be monitored. Simultaneously, it is possible to monitor the voltage made available by the voltage supply, in particular by the rechargeable battery, and if a predetermined minimum voltage is undershot to prevent a total discharge of the rechargeable battery. Moreover, the current flowing in the power circuit 20 can simultaneously be monitored in order, if a maximum allowable current is exceeded, to be able to take countermeasures for reducing the current, and these measures can range as far as the shutoff of the electric tool 10.

For monitoring the temperature-sensitive components of the electric tool, there are various possibilities with which a transition can be made from a critical mode of operation to a noncritical mode of operation. For instance, an evaluation circuit for the temperature detection can output a steady signal. If discretely adjustable limit value stages are reached, the set-point value is adapted via the set-point value made available in the logic unit 34, and the rpm and power are reduced, optionally to the extent of stoppage of the electric tool 10.

In an alternative variant for the evaluation, a steady signal is again output by the temperature detector. When continuous limit values are reached, the set-point value signal is varied continuously via the logic unit 34.

The temperature evaluation circuit can furthermore be embodied such that if a set limit is reached, the set-point value signal is set to zero.

The set-point value signal for the temperature signal can also be coupled directly to the actual temperature signal, so that a separate evaluation for that can be dispensed with. In that case, a change in the temperature directly affects the set-point value signal.

To avoid fluctuations in the circuit, hysteresis known per se can be implemented in the circuit of the logic unit 34 or in the sensor signal detector 30.

For voltage monitoring, a minimum value for the input voltage is defined for the set-point value of the voltage. When this minimum input voltage is reached or undershot, different variants for protection of the electric tool 10 can be realized. For instance, the supply voltage of all the electronics can be shut off. Moreover, via the logic unit 34, a reset can be performed, and in the process an existing frequency generator, which for instance generates a pulse width modulated signal for triggering the power circuit, can be shut off and locked. The frequency signal, which is embodied for instance as a pulse width modulated signal and is delivered to the power circuit 20, can also be blocked.

The current monitoring can be done for instance such that with a so-called intelligent power switch (IPS), the allowable current in the power component is limited. Thus that component is protected against an excessively high current flow and a resultant impermissible overheating. In addition, independent temperature monitoring can also be provided.

With the proposed monitoring system, a transition from a critical operating state of the electric tool 10 to a noncritical state can be made by means of an rpm reduction or a shutoff of the electric tool 10. Thus on the one hand the electric tool 10 itself is protected. On the other, a contribution can also be made to avoid personal injury to the user.

The protection circuit 26 is integrated with the device switch 12 and is preferably embodied such that it can act directly on the power circuit 20.

FIG. 3 shows a schematic block circuit diagram of a second embodiment of a functionality integrated with the device switch 12. The circuit schematically shown in FIG. 3 includes both the functionality of the power circuit 20 and the functionality of the protection circuit 26 of FIG. 1.

The circuit shown in FIG. 3 includes a logic unit 101. The logic unit 101 is connected to a first temperature monitoring device 110 for monitoring the temperature of a voltage source 103 of the electric tool 10. The voltage source 103 of the electric tool 10 may for instance be a rechargeable battery. The temperature monitoring device 110 for monitoring the temperature of the voltage source 103 measures the temperature of the voltage source 103 continuously and compares the measured temperature with a predetermined limit temperature. As soon as the temperature of the voltage source 103 ascertained by the temperature monitoring device 110 exceeds the defined limit value, the temperature monitoring device 110 outputs a signal to the logic unit 101.

The logic unit 101 is also in communication with a temperature monitoring device 111 for monitoring the temperature of a power circuit 106. The temperature monitoring device 111 ascertains the temperature of the power circuit 106 continuously and compares it with a defined limit temperature. As soon as the ascertained temperature of the power circuit 106 exceeds the defined limit value, the temperature monitoring device 111 outputs a corresponding signal to the logic unit 101.

The logic unit 101 is also in communication with a temperature monitoring device 112 for monitoring the temperature of a motor 108. The temperature monitoring device 112 ascertains the temperature of the motor 108 continuously and compares it with a defined limit value. As soon as the ascertained temperature of the motor 108 exceeds the defined limit value, the temperature monitoring device 112 outputs a corresponding signal to the logic unit 101.

The temperature monitoring devices 110, 111, 112 are each connected to a temperature sensor, which is in good thermal contact with the component of the electric tool 10 that monitored by the applicable temperature monitoring device. The temperature monitoring devices 110, 111, 112 furthermore each have an evaluation circuit, which serves to evaluate the signal furnished by the respective temperature sensor, performs the comparison with the respective defined limit value, and generates a signal dependent on the outcome of this comparison and outputs it to the logic unit 101.

The logic unit can in addition be in communication with further temperature monitoring devices for monitoring the temperature of other electric or electronic or other components of the electric tool 10.

The logic unit 101 is also connected to a voltage monitoring device 104, which is provided for monitoring a voltage furnished by the voltage source 103 of the electric tool 10. The voltage monitoring device 104 compares the voltage furnished by the voltage source 103 with a predetermined limit value. If the voltage furnished by the voltage source 103 undershoots the predetermined limit value, the voltage monitoring device 104 furnishes a corresponding signal to the logic unit 101. The voltage monitoring device 104 can compare the voltage furnished by the voltage source 103 with a reference voltage of a Xener diode, for instance by means of a comparator.

The logic unit 101 is also in communication with a current monitoring device 107 for monitoring a current flowing in the power circuit 106. The current monitoring device 107 continuously ascertains the current flowing in the power circuit 106 and compares it with a defiled limit value. If the current flowing in the power circuit 106 overshoots the defined limit value, the current monitoring device 107 furnishes a corresponding signal to the logic unit 101.

The logic unit 101 is also connected to a set-point value predeterminer 102 furnishes a set-point value that is dependent on the position of the trigger 14 of the device switch 12. The set-point value that is output by the set-point value predeterminer 102 to the logic unit 101 thus reflects what the user of the electric tool 10 wants. If the user of the electric tool does not actuate the trigger 14 of the device switch 12 at all, the set-point value predeterminer 102 furnishes a set-point value of 0%. If the user of the electric tool 10 depresses the trigger 14 of the device switch 12 halfway, the set-point value predeterminer 102 furnishes a set-point value of 50%. If the user depresses the trigger 14 completely, the set-point value predeterminer 102 furnishes a set-point value of 100% to the logic unit 101.

In a further embodiment of the invention, the trigger 14 is embodied as a button. In this embodiment, the set-point value predeterminer 102 furnishes set-point values of only either 0% or 100% to the logic unit 101.

From the set-point value furnished by the set-point value predeterminer 102, the logic unit 101 ascertains an adapted set-point value. In doing so, the logic unit 101 takes into account the signals furnished by the temperature monitoring devices 110, 111, 112. For ascertaining the adapted set-point value, the logic unit 101 can also take into account the signals furnished by the voltage monitoring device 104 and by the current monitoring device 107. If none of the monitoring devices mentioned indicates a critical state of one of the monitored components of the electric tool 10, the logic unit 101 can adopt the set-point value furnished by the set-point value predeterminer 102 directly as the adapted set-point value. Alternatively, the logic unit 101 can perform an arbitrary scaling of the set-point value furnished by the set-point value predeterminer 102. To reduce switchover losses of the power circuit 106, the logic unit 101 can as the adapted set-point value adopt the set-point value of the set-point value predeterminer 102 within a defined lower range of the set-point value, up to 40%, for example, but conversely can convert a higher set-point value furnished by the set-point value predeterminer 102 directly into an adapted set-point value of 100%.

If one of the monitoring devices described indicates a critical state of a component of the electric tool 10, the logic unit 101 can perform a reduction of the adapted set-point value. In that case, the logic unit 101 can reduce the adapted set-point value to 0%, for instance.

In another embodiment of the invention, the temperature monitoring devices 110, 111, 112 of the logic unit 101 furnish a signal that is dependent on whatever temperature has been ascertained. In this embodiment of the invention, the logic unit 101 can reduce the adapted set-point value increasingly, with increasing temperatures of the components monitored by the temperature monitoring devices 110, 111, 112. The reduction in the adapted set-point value can be done for instance in one or more discrete stages. The reduction in the adapted set-point value can also be done continuously with increasing temperatures. In each ease, the adapted set-point value is reduced with the goal of avoiding overheating of one of the monitored components of the electric tool 10.

The logic unit 101 outputs the adapted set-point value to a unit 105 for generating a pulse width modulated signal. The unit 105 for generating a pulse width modulated signal generates a pulse width modulated signal with a duty cycle corresponding to the adapted set-point value. The unit 105 for generating the pulse width modulated signal outputs the pulse width modulated signal to the power circuit 106.

A power circuit 106 supplies the motor 108 of the electric tool 10 the pulse width modulated signal correspondingly with voltage. The power circuit 106 can be embodied for instance as a power MOSFET, whose gate contact is switched by the pulse width modulated signal.

The current monitoring device 107 monitors the current flowing through the power circuit 106. For that purpose, the voltage drop at a series resistor (shunt) can for instance be measured. If the power circuit 106 is embodied as a power MOSFET, the current monitoring device 107 can alternatively monitor the resistance R_{DS(on)} of the power MOSFET. This is preferably done using passive components as P, PI, PID or PD controllers with an operational amplifier.

In alternative embodiments, the power circuit 106 and the current monitoring device 107 can be embodied as an integrated power semiconductor. Such components are available from various manufacturers by the names “Intelligent Power Switch”, “SmartFET”, “TempFET”, “SenseFET”, “HITFET”, etc. Depending on the embodiment, the temperature monitoring device 111 for monitoring the temperature of the power circuit 106 can also be provided inside this integrated power semiconductor. In addition, still other monitoring functions, for instance for monitoring the voltage applied to the power circuit 106, can be integrated as well. The integrated component comprising the power circuit 106 and the current monitoring device 107 can also be embodied for shutting off the power circuit 106 in the event of an impermissibly high current intensity, an impermissibly high temperature, or an impermissibly high applied voltage. In that case, the feedback to the logic unit 101 can alternatively be omitted. If a feedback to the logic unit 101 is provided, then in the event of a critical operating state of the power circuit 101, the logic unit 101 can additionally deactivate further components of the electric tool 10, such as the unit 105 for generating the pulse width modulated signal.

The logic unit 101 can be embodied for shutting off individual groups of components of the electric tool 10 in the event of an impermissibly low voltage of the voltage source 103. In such a case, the logic unit 101 can for instance shut off the unit 105 for generating the pulse width modulated signal and/or the power circuit 106. As a result, a harmful total discharge of the rechargeable battery that forms the voltage source 103 is prevented.

In another embodiment of the invention, the generation, monitoring, and shutoff of the supply voltage can also be performed by an integrated circuit.

According to the invention, the logic unit 101, the temperature monitoring devices 110, 111, 112, the unit 105 for generating the pulse width modulated signal, the power circuit 106, the current monitoring device 107, the set-point value predeterminer 102, and the voltage monitoring device 104 can be disposed inside the device switch 12 of the electric tool 10. Preferably, all the components described are embodied as analog circuits, which is especially economical.

1-19. (canceled)

20. A device switch for an electric tool, in particular an electric tool with rechargeable battery operation, having
a power circuit for supplying voltage to a motor integrated with the device switch, and
an electronic circuit, in particular a protection circuit, which monitors a temperature, a voltage, and/or a current, integrated with the device switch.

21. The device switch as defined by claim 20, wherein the electronic circuit is embodied as an analog electronic circuit.

22. The device switch as defined by claim 20, wherein the power circuit and the electronic circuit are integrated on a common circuit board.

23. The device switch as defined by claim 20, further having a circuit generating a pulse width modulated signal, and the pulse width modulated signal triggering the power circuit, and the pulse width modulated signal speed controlling and/or regulating of the motor, wherein the speed controlling and/or regulating is effected as a function of monitored values for the temperatures, the current, and/or the voltage.

24. The device switch as defined by claim 23, wherein the circuit generating the pulse width modulated signal and/or the power circuit is capable of being shut off if one of the variables monitored by the electronic circuit reaches a defined limit value.

25. The device switch as defined by claim 20, wherein the electronic circuit has a device for monitoring the voltage of a voltage source, in particular of a rechargeable battery.

26. The device switch as defined by claim 20, wherein the electronic circuit is embodied for monitoring and/or regulating a current flowing in the power circuit.

27. The device switch as defined by claim 26, wherein a shunt resistor is provided for monitoring the current.

28. The device switch as defined by claim 26, wherein the electronic circuit is embodied for current monitoring of the voltage dropping across a transistor of the power circuit.

29. An electric tool, in particular an electric tool with rechargeable battery operation, wherein the electric tool has a device switch as defined by claim 1.

30. The electric tool as defined by claim 29, wherein the electric tool has a temperature sensor for monitoring a motor temperature.

31. The electric tool as defined by claim 29, wherein the electric tool has a temperature sensor monitoring a temperature of an electric or electronic component.

32. The electric tool as defined by claim 30, wherein the electric tool has a temperature sensor monitoring a temperature of an electric or electronic component.

33. The electric tool as defined by claim 10, wherein the electric tool has a temperature sensor monitoring a temperature of a rechargeable battery.

34. The electric tool as defined by claim 10, wherein by means of monitoring of a maximum current flowing in the power circuit, a limitation is brought about in a torque furnished by the electric tool.

35. A method for monitoring an electric tool, in particular an electric tool with rechargeable battery operation, having a device switch, in which the device switch has a power circuit supplying voltage to a motor, wherein a temperature of at least one component of the electric tool, a current through the power circuit, and/or a supply voltage, in particular a rechargeable battery voltage, is monitored, and by means of an electronic circuit, in particular a protection circuit, a speed control and/or regulation is effected as a function of monitored values for the temperature, the current, and/or the voltage.

36. The method as defined by claim 15, wherein the electronic circuit controls and/or regulates the rpm in a predetermined range, and if this range is exceeded, the value for the rpm is set to a maximum possible value.

37. The method as defined by claim 16, wherein the predetermined range is between 0% and 50% of maximum possible rpm.

38. The method as defined by claim 15, wherein upon attainment or overshooting of a defined temperature of a monitored component, a change is made to a safer mode of operation.

39. The method as defined by claim 15, wherein upon attainment or undershooting of a predetermined minimum voltage, the electric tool is shut off.
